(19) United States
(12) Patent Application Publication
(10) Pub. No.: US 2026/0119801 A1
(43) Pub. Date: Apr. 30, 2026

(54) BEHAVIORAL PROFILING OF ARTIFICIAL INTELLIGENCE AGENTS USING A MULTI-DIMENSIONAL VECTOR FRAMEWORK

(71) Applicant: BOOMI, LP, Conshohocken, PA (US)

(72) Inventors: Alexander KARLOVITZ, Philadelphia, PA (US); Ayush PARASHAR, Foster City, CA (US); Sandeep SINGH, Cumming, GA (US)

(73) Assignee: BOOMI, LP, Conshohocken, PA (US)

(21) Appl. No.: 19/335,796

(22) Filed: Sep. 22, 2025

(30) Foreign Application Priority Data
Oct. 25, 2024 (IN) 202411081537
Oct. 25, 2024 (IN) 202411081538

(51) Int. Cl. G06F 40/30; G06F 16/334; G06F 16/34

(52) U.S. Cl. CPC G06F 40/30; G06F 16/3347; G06F 16/345

(57) ABSTRACT

As the number of AI agents in operation has increased, it has become difficult to analyze and search registries of AI agents. Disclosed embodiments enable a holistic view of the behaviors of AI agents, including governance and/or human-like behaviors, both individually and in relation to the behaviors of other AI agents. In particular, a profiling service may embed each of a plurality of behaviors of each AI agent into the same vector space by feeding heterogeneous data about the AI agent through an AI model, converting the output of the AI model into an embedding vector, and storing the embedding vector in a vector database in association with the AI agent. The behaviors that are embedded into the vector space may comprise governance behaviors, human-like behaviors, and/or any other category of behavior. This provides scalability and explainable searches and comparisons of AI agents, behavior-wise or by any set of behaviors.

### CROSS-REFERENCE TO RELATED APPLICATIONS

The present application claims priority to Indian Patent Application number 202411081537, filed on Oct. 25, 2024, and Indian Patent Application number 202411081538, filed on Oct. 25, 2024, which are both hereby incorporated herein by reference as if set forth in full.

### BACKGROUND

### Field of the Invention

The embodiments described herein are generally directed to artificial intelligence (AI), and, more particularly, to the scalable behavioral profiling of AI agents using a multi-dimensional vector framework for improved searchability and explainability.

### Description of the Related Art

Numerous platforms exist that enable users to construct and/or utilize artificial intelligence (AI) agents. An AI agent is a software entity that utilizes artificial intelligence to autonomously perform one or more tasks, in order to achieve an objective set by a human, other software entity (e.g., another AI agent), or other system. An AI agent may comprise or communicate with one or more integrated, local, or remote AI models, such as generative AI models (e.g., generative language models, generative image models, generative coding models, etc.). An AI agent may also communicate with one or more tools that are external to the AI agent, to complete tasks in furtherance of its objective.

As the number of AI agents in operation continues to rapidly increase, it has become more difficult to find the appropriate AI agent for a given task. In particular, it has become more difficult, not only to search amongst available AI agents, but also to compare two AI agents to each other. Conventionally, AI agents are searched based on keywords or tags, with rule-based filters on the metadata of the AI agents. However, such an approach is unable to capture behavioral nuance or synonymy between AI agents. And while two AI agents may be compared using lexical similarity metrics, such as Jaccard similarity or Term Frequency-Inverse Document Frequency (TF-IDF), these metrics are unable to measure semantic equivalence and compare non-textual information, such as the governance constraints on AI agents.

As a result, redundant or near-duplicate AI agents proliferate, which increases maintenance and auditing costs. In addition, the state of the art possesses no holistic view of an AI agent's behavior, such as how the AI agent's governance posture interacts with its human-facing behavior. There is also difficulty in pinpointing policy gaps, such as “AI agents that answer with an empathetic tone, but lack payment card industry (PCI)-compliant guardrails.” In general, it has become difficult to manage, search, and audit AI agents in a scalable and explainable manner.

### SUMMARY

Accordingly, systems, methods, and non-transitory computer-readable media are disclosed for the scalable behavioral profiling of AI agents using a multi-dimensional vector framework for improved searchability and explainability.

In an embodiment, a method comprises using at least one hardware processor to, by a profiling service: receive agent data for an artificial intelligence (AI) agent; for each of a plurality of behaviors, generate a prompt for the behavior from at least a portion of the agent data, apply a generative language model to the prompt to generate a summary of the behavior for the AI agent, and convert the summary into an embedding vector that represents a semantic meaning of the summary within a vector space, and add the embedding vector to an agentic behavioral profile for the AI agent; and add each of the embedding vectors in the agentic behavioral profile to a vector database.

The agent data may comprise metadata for the AI agent.

The agent data may comprise a conversation history for AI agent. The conversation history may comprise a transcript of each of one or more sessions between an end client and the AI agent. The conversation history may comprise a summary of each of one or more sessions between an end client and the AI agent.

Generating the prompt may comprise: selecting a behavior-specific instruction that is associated with the behavior, from among a plurality of behavior-specific instructions; and incorporating the at least a portion of the agent data and the behavior-specific instruction into a template, to produce the prompt.

The generative language model may be a large language model.

The vector space may have at least one-hundred dimensions.

Each of the embedding vectors may be associated, within the vector database, with an agent identifier of the AI agent. Each of the embedding vectors may be associated, within the vector database, with a behavior identifier of one of the plurality of behaviors that is represented by the embedding vector.

The plurality of behaviors may comprise one or more governance behaviors. The plurality of behaviors may comprise one or more human-like behaviors. The plurality of behaviors may comprise one or more governance behaviors and one or more human-like behaviors.

The method may further comprise using the at least one hardware processor to, by a search engine: receive a query from an end client; search the vector database based on the query to produce a search result comprising one or more agent identifiers, wherein each of the one or more agent identifiers identifies one of a plurality of AI agents represented in the vector database; and return the search result to the end client in response to the query. The query may define one or more behaviors, wherein searching the vector database based on the query to produce the search result comprises: for each of the one or more defined behaviors, generating an input embedding vector representing the defined behavior, generating a vector-database query that queries the vector database for matching reference embedding vectors that are similar, according to one or more similarity criteria, to the input embedding vector, and executing the vector-database query to retrieve any matching reference embedding vectors; determine a final set of matching reference embedding vectors; and add an agent identifier associated with each of the matching reference embedding vectors, in the final set, to the search result. The query may identify one or more input AI agents, wherein searching the vector database based on the query to produce the search result comprises: for each of the one or more input AI agents, retrieve at least one embedding vector for the input AI agent from the vector database, generate a vector-database query that queries the vector database for matching reference embedding vectors that are similar, according to one or more similarity criteria, to the at least one embedding vector, and execute the vector-database query to retrieve any matching reference embedding vectors; determine a final set of matching reference embedding vectors; and add an agent identifier associated with each of the matching reference embedding vectors, in the final set, to the search result. The search engine may be hosted on an integration platform as a service (iPaaS) platform.

The profiling service may be hosted on an integration platform as a service (iPaaS) platform.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example data flow for the behavioral profiling of AI agents using a multi-dimensional vector framework, according to an embodiment;

FIG. 4 illustrates an example process for the behavioral profiling of AI agents using a multi-dimensional vector framework, according to an embodiment; and

FIG. 5 illustrates an example process for searching AI agents using a multi-dimensional vector framework, according to an embodiment.

### DETAILED DESCRIPTION

In an embodiment, systems, methods, and non-transitory computer-readable media are disclosed for the scalable behavioral profiling of AI agents using a multi-dimensional vector framework for improved searchability and explainability. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. INFRASTRUCTURE

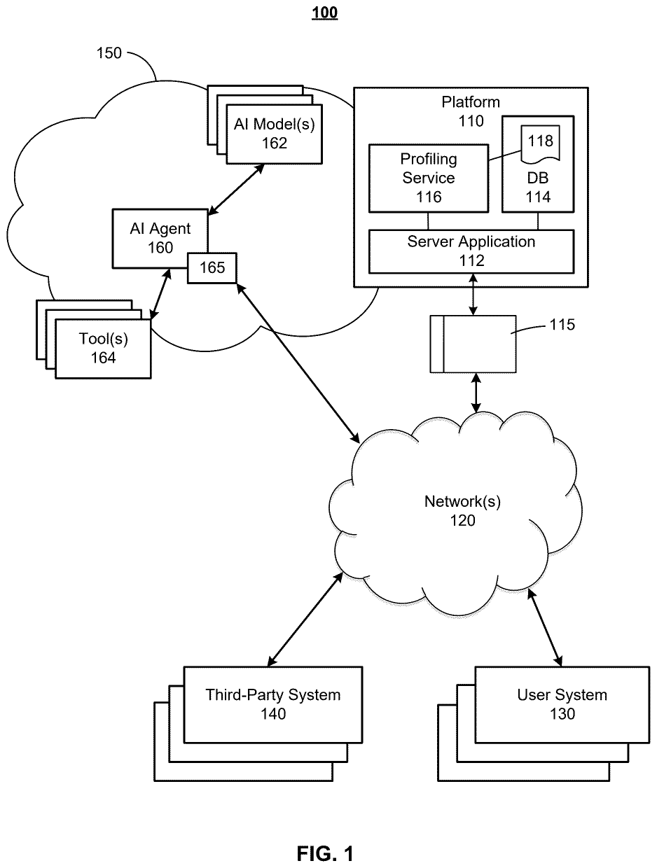

FIG. 1 illustrates an example infrastructure 100, in which one or more of the processes described herein may be implemented, according to an embodiment. Infrastructure 100 may comprise a platform 110 which hosts, supports, and/or executes one or more of the disclosed processes, which may be implemented in software and/or hardware. In particular, platform 110 may execute a server application 112, and/or host a database 114 that may store data used and/or generated by server application 112 and/or other components of platform 110. Platform 110 may also execute a profiling service 116 (e.g., as part of or in collaboration with server application 112), which generates behavioral profiles for AI agents 160 to be stored in a vector database 118 (e.g., within database 114), as described in greater detail elsewhere herein. Profiling service 116 may itself be an AI agent 160, although this is not a requirement. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and one or more user systems 130 and/or third-party systems 140. Network(s) 120 may comprise the Internet, and communication through network(s) 120 may utilize standard transmission protocols, such as HTTP, HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 and/or third-party system(s) 140 through a single set of network(s) 120, it should be understood that platform 110 may be connected to different user systems 130 and/or third-party systems 140 via different sets of one or more networks. For example, platform 110 may be connected to a subset of user systems 130 and/or third-party systems 140 via the Internet, but may be connected to another subset of user systems 130 and/or third-party systems 140 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of a developer or other stakeholder in AI agents 160, and who has a user account for accessing server application 112 on platform 110. It should be understood that the user may be anywhere from an expert software engineer, with extensive knowledge of how AI agents 160 work, to a business decision-maker, lay person, or other non-technical person, with little to no knowledge of how AI agents 160 work. Each user account may be associated with an overarching organizational account for developing, utilizing, or otherwise managing software entities, including AI agents 160, for an organization using platform 110.

Server application 112 may manage a computing environment 150. In particular, server application 112 may provide a user interface 115 and backend functionality, including one or more of the processes disclosed herein, to enable or otherwise support users, via user systems 130, to construct, develop, modify, save, delete, test, deploy, un-deploy, utilize, and/or otherwise manage software entities within computing environment 150. User interface 115 may comprise a graphical user interface that implements a low-code environment, including potentially a no-code environment, in which users may manage software entities. These software entities may comprise AI agents 160, and potentially other software entities, such as integration processes. While only a single AI agent 160 is illustrated, it should be understood that computing environment 150 may comprise or be communicatively coupled to a plurality of AI agents 160, including potentially hundreds, thousands, millions, tens of millions, hundreds of millions, billions, tens of billions, hundreds of billions, or more AI agents 160.

The user of a user system 130 may authenticate with platform 110 using standard authentication means, to access server application 112 in accordance with permissions or roles of the associated user account. The user may then interact with server application 112 to manage one or more software entities, for example, within a larger software platform within computing environment 150. It should be understood that multiple users, on multiple user systems 130, may manage the same software entities and/or different software entities in this manner, according to the permissions or roles of their associated user accounts.

In an embodiment, platform 110 may be an integration platform as a service (iPaaS) platform. In this case, the software entities(s) being developed may include integration process(es). Computing environment 150 may comprise one or a plurality of integration platforms that each comprises one or a plurality of integration processes. Each integration platform may be associated with an organization, which may be associated with one or more user accounts by which respective user(s) manage the organization's integration platform, including the various integration process(es). An integration process may represent a transaction involving the integration of data between two or more systems, and may comprise a series of elements that specify logic and transformation requirements for the data to be integrated. Each element, which may also be referred to as a “step,” may transform, route, and/or otherwise manipulate data to attain an end result from input data. For example, a basic integration process may receive data from one or more data sources (e.g., via an application programming interface (API) of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software. These integration processes, and/or the development and/or management of these integration processes, may be supported by one or more AI agents 160, and/or the integration processes may support one or more AI agents 160.

Each integration process, when deployed, may be communicatively coupled to network(s) 120. For example, each integration process may comprise an application programming interface that enables clients to access an integration process via network(s) 120. A client may push data to an integration process through application programming interface, and/or pull data from an integration process through application programming interface.

Similarly, each AI agent 160, when deployed, may be communicatively coupled to network(s) 120. In particular, each AI agent 160 may comprise an agentic interface 165, which may comprise a user interface, including potentially a graphical user interface, and/or an application programming interface. An end client (e.g., user system 130 or third-party system 140) may interact with AI agent 160, via agentic interface 165, to submit inputs and receive responses from AI agent 160, push data to AI agent 160, pull or otherwise receive data from AI agent 160, and/or the like. In the event that agentic interface 165 comprises a user interface, AI agent 160 may be a conversational agent that receives natural-language inputs from a user and outputs natural-language responses to the user.

One or more third-party systems 140 may be communicatively connected to network(s) 120, such that each third-party system 140 may communicate with an AI agent 160 and/or integration process in computing environment 150 via an application programming interface. Third-party system 140 may host and/or execute a software application that pushes data to an AI agent 160 and/or integration process and/or pulls data from an AI agent 160 and/or integration process, via the application programming interface of the AI agent 160 and/or integration process. Additionally or alternatively, an AI agent 160 and/or integration process may push data to a software application on third-party system 140 and/or pull data from a software application on third-party system 140, via an application programming interface of the third-party system 140. Thus, third-party system 140 may be a consumer of one or more AI agents 160 and/or integration processes, a data source for one or more AI agents 160 and/or integration processes, and/or the like. As examples, the software application on third-party system 140 may comprise, without limitation, enterprise resource planning (ERP) software, customer relationship management (CRM) software, accounting software, and/or the like.

As mentioned above, the software entities(s) being managed on platform 110 include AI agents 160. An AI agent 160 is any software entity that utilizes artificial intelligence (e.g., machine learning, natural-language processing, data analytics, etc.), embodied in one or more AI models 162, to autonomously perform a task, in order to achieve an objective set by a human, other software entity, or other system. AI agent 160 may collect data, analyze data, communicate with human users and/or other software entities, collaborate with other AI agents 160 to complete a complex task, execute actions, learn and improve over time, and/or the like.

Each AI agent 160 comprises or is communicatively coupled to at least one AI model 162. AI model 162 may be internal to AI agent 160, external but local (i.e., within computing environment 150) to AI agent 160, or external and remote (i.e., outside computing environment 150, e.g., hosted on third-party system 140, etc.) from AI agent 160. An AI model 162 may be a generative AI model, such as a generative language model (e.g., small language model, large language model, etc., that responds to natural-language prompts in natural language), generative image model (e.g., that responds to natural-language prompts with an image), generative video model (e.g., that responds to natural-language prompts with a video), generative coding model (e.g., that responds to natural-language prompts with software code), or the like. As used herein, the term “natural language” or “natural-language” refers to language, including grammar, that would be expected in a normal conversation between two humans. A pre-trained generative AI model may be used as a base model that is fine-tuned for the specific task of AI agent 160, to produce AI model 162.

One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the DeepSeek family of large language models from DeepSeek AI of Hangzhou, Zhejiang, China, any of the Claude family of large language models (e.g., Claude 3 Opus, Claude 3.7 Sonnet, etc.) developed by Anthropic PBC of San Francisco, California, the Falcon large language model (e.g., Falcon 160B) released by the United Arab Emirates' Technology Innovation Institute (TII), the Large Language Model Meta AI (LLaMA) model (e.g., LLAMA 2) released by Meta AI of New York, New York, any of the Gemini family of large language models from Google LLC of Mountain View, California, any of the Mistral family of models released by Mistral AI of Paris, France, and the like.

Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney form Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like.

Examples of generative video models include, without limitation, Runway Gen-2, the Pika family of models from Pika Labs AI of San Francisco, California, Lumiere from Google LLC, VideoLDM from Nvidia, Make-A-Video from Meta Platforms, Inc. of Menlo Park, California, Synthesia from Synthesia of London, England, United Kingdom, DeepBrain AI from AI Studios of Palo Alto, California, Stable Video Diffusion from Stability AI Ltd, and the like.

Examples of generative coding models include, without limitation, Codex from OpenAI, AlphaCode from Google LLC, Code LLAMA from Meta AI, AlphaFold Code from DeepMind Technologies Limited of London, England, United Kingdom, CodeWhisperer from Amazon Web Services of Seattle, Washington, CodeGen from Salesforce, Inc. of San Francisco, California, StarCoder developed by Hugging Face and ServiceNow Research, Tabnine from Tabnine of Tel Aviv, Israel, and the like.

Each AI agent 160 may comprise or be communicatively coupled to zero, one, or a plurality of tools 164. Tool(s) 164 may be hosted within computing environment 150 (e.g., a cloud-computing environment) and/or externally to computing environment 150 (e.g., on a third-party system 140). Tools 164 enable an AI agent 160 to interact with external systems, and even potentially, the physical world. Each tool 164 may perform a sub-task for the overall task of AI application 160. A sub-task may comprise retrieving data from a source (e.g., another software entity, a local database hosted within computing environment 150, a remote database hosted externally to computing environment 150, a third-party system, application, or database, an integration process, etc.), transforming, formatting, mapping, cleaning, or otherwise manipulating data, analyzing data, storing data, sending data (e.g., tabular or other structured data, unstructured data, commands, requests, queries, etc.) to a destination (e.g., another software entity, a local database, a remote database, a third-party system, application, or database, an integration process, etc.), initiating a transaction (e.g., purchase, sale, exchange, trade, etc.), completing a transaction, actuating a physical device (e.g., activate a motor, switch, or other machine component, set or adjust a setpoint for a control parameter, etc.), and/or the like.

In some cases, an AI agent 160 may be a conversational or chat AI agent. In this case, agentic interface 165 may implement a chat interface. The chat interface may be comprised or embedded (e.g., as an overlaid chat frame) within a user interface of agentic interface 165, which may itself be comprised or embedded within user interface 115 of server application 112. The chat interface may be a graphical user interface, an audio interface, or a combination of graphical and audio user interface (i.e., an audiovisual interface).

### 2. EXAMPLE PROCESSING SYSTEM

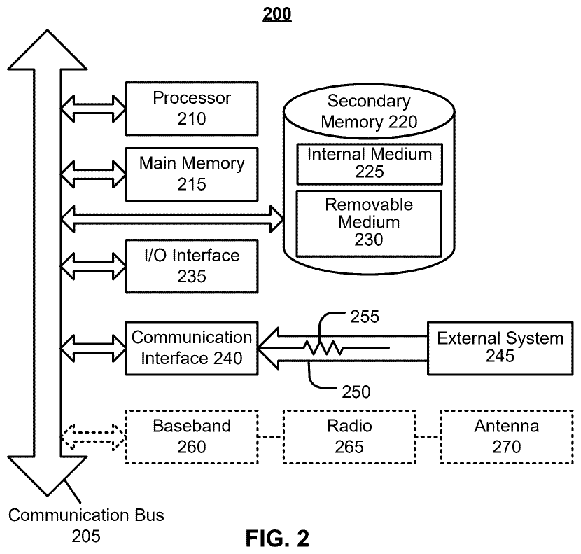

FIG. 2 illustrates an example processing system 200, by which one or more of the processes described herein may be executed, according to an embodiment. For example, system 200 may be used to store and/or execute server application 112, profiling service 116, AI agent(s) 160, AI model(s) 162, and/or tool(s) 164, host database 114 (e.g., including vector database 118), and/or may represent components of platform 110, user system(s) 130, third-party system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. DATA FLOW

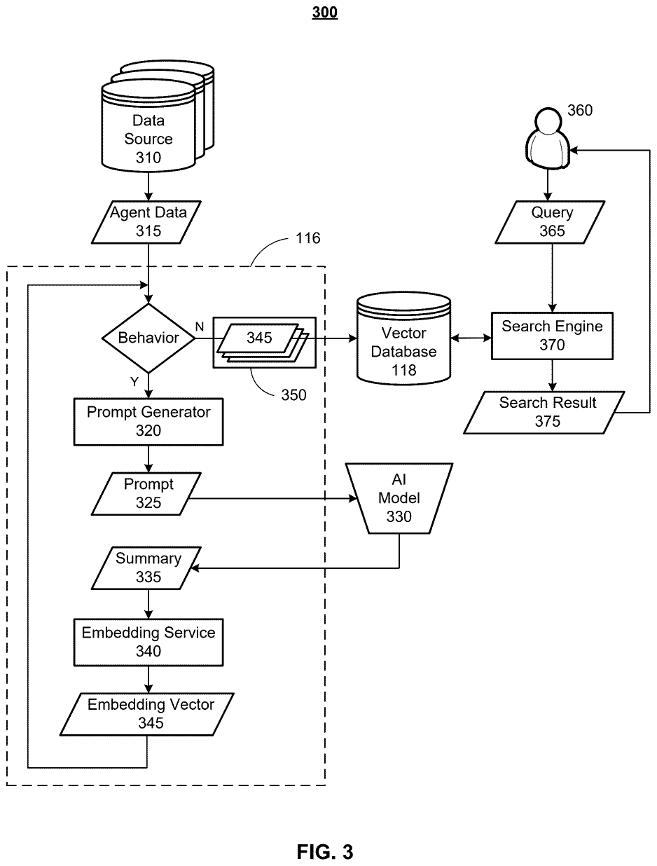

FIG. 3 illustrates an example data flow 300 for the behavioral profiling of artificial intelligence (AI) agents using a multi-dimensional vector framework, according to an embodiment. It should be understood that data flow 300 is shown by way of example, rather than limitation, and that a myriad other arrangements of the data flow are possible. In the illustrated embodiment, profiling service 116 comprises a prompt generator 320 and embedding service 340.

Profiling service 116 may be triggered automatically or manually. For example, profiling service may be triggered automatically whenever a new AI agent 160 is deployed to computing environment 150 and/or added to a registry of AI agents 160 that are available on platform 110 and/or within computing environment 150. Alternatively or additionally, profiling service 116 may be triggered periodically to process all AI agents 160 that have been deployed to computing environment and/or added to the registry of AI agents 160 since the last execution (i.e., in batches). Alternatively or additionally, profiling service 116 may be triggered manually by a user via a user interface of profiling service 116 (e.g., user interface 115 if profiling service is part of server application 112, or agentic interface 165 if profiling service 116 is an AI agent 160). Alternatively or additionally, profiling service 116 may be triggered by any other event for which it makes sense to make at least one AI agent 160 searchable by behavior.

When triggered, profiling service 116 may receive agent data 310 from one or more data sources 310. Agent data 310 may be submitted or pushed to profiling service 116 from data source(s) 310, or profiling service 116 may retrieve or pull agent data 310 from data source(s) 310. In the former case, agent data 310 for each of one or more AI agents 160 may be submitted as an input when calling profiling service 116, or may be pushed to profiling service 116, for example, by a publish-and-subscribe system, in which profiling service 116 subscribes to a stream of agent data 315 for newly deployed and/or registered AI agents 160. In the latter case, an agent identifier for each of one or more AI agents 160 (e.g., newly deployed and/or registered AI agents 160) may be submitted as input to profiling service 116, and profiling service 116 may retrieve agent data 315, from data source(s) 310, for each of the AI agent(s) 160, using the respective agent identifier as an index.

For the sake of simplicity and clarity, the following description will assume that profiling service 116 is processing agent data 315 for a single AI agent 160. However, it should be understood that profiling service 116 may process agent data 315 for a plurality of AI agents 160, in parallel, simultaneously, contemporaneously, independently, and/or asynchronously. For example, profiling service 116 could process agent data 315 for a plurality of AI agents 160 in batches.

In an embodiment, agent data 315 comprise metadata and a conversation history for each AI agent 160 to be processed. The metadata and conversation history may be obtained from the same data source 310 or multiple data sources 310. For example, the metadata for AI agent 160 may be obtained from a registry of AI agents 160, that includes the AI agent 160 to be processed. The registry may be stored in database 114 or another database. The conversation history for AI agent 160 may be obtained from database 114 or another database. While it will be assumed that agent data 315 comprise both metadata and conversation history, in an alternative embodiment, agent data 315 may comprise or consist of only metadata or only conversation history. For instance, for AI agents 160 that are not conversational or which have never been used before, there may be no conversation history. It should be understood that agent data 315 for an AI agent 160 may comprise additional relevant data, besides metadata and/or a conversation history.

The metadata may comprise any information persistently stored for AI agent 160, including, for example, the name of the AI agent, design-time system prompts used by AI agent 160 (e.g., an orchestration layer of AI agent 160), an identifier of each AI model 162 used by AI agent 160, other data (e.g., metrics, hyperparameters, model architecture, training data sources, fine-tuning details, etc.) for each AI model 162 used by AI agent 160, an identifier of each tool 164 used by AI agent 160, other data for each tool 164 (e.g., metrics, inputs, outputs, capabilities, etc.) used by AI agent 160, a primary function or task of AI agent 160, one or more capabilities (e.g., supported modalities, supported languages, knowledge domains, integration interfaces, input constraints, output formats, scaling capabilities, etc.) of AI agent 160, a description of AI agent 160, one or more metrics (e.g., performance metric(s), usage metric(s), etc.) for AI agent 160, the developer of AI agent 160, a license type for AI agent 160, a version of AI agent 160, computational requirements of AI agent 160, guardrails applicable to AI agent 160, data privacy policy of AI agent 160, data retention policy of AI agent 160, bias and fairness of AI agent 160, regulatory compliance for AI agent 160, one or more logs for AI agent 160, identifier and/or other information about the hosting environment of AI agent 160, one or more platforms supported by AI agent 160, one or more configurable settings (e.g., personality, style, tone, temperature, etc.) of AI agent 160, user feedback for AI agent 160, explainability features of AI agent 160, authentication methods for AI agent 160, encryption standards used by AI agent 160, authorization level required to use AI agent 160, dependencies of AI agent 160, interoperating protocols used by AI agent 160, and/or the like.

The conversation history may represent historical sessions between AI agent 160 and each of one or more end clients. An end client may be a human user or a software entity. The conversation history may comprise the full set of interactions during a session, including each input by the end client and each response by AI agent 160 during the session. In other words, the conversation history may comprise a transcript of each session. Alternatively or additionally, the conversation history may comprise a summary of each session. In this case, the summary of each session may be generated by inputting the transcript of a session into a generative language model, such as a large language model, which may be fine-tuned to summarize transcripts, to output a summary of the transcript for the session.

At a high level, profiling service 116 generates a plurality of embedding vectors 345 for AI agent 160. The plurality of embedding vectors 345 comprises, for each of a plurality of behaviors, an embedding vector 345 that semantically represents the nature of that behavior in AI agent 160. The plurality of behaviors may comprise different categories of behaviors. Exemplary categories of behaviors include, without limitation, governance behaviors and human-like behaviors. Examples of governance behaviors include, without limitation, data sensitivity guardrails, regulatory scope, allowed tool surface, and safety alignment. Examples of human-like behaviors include, without limitation, tone and empathy, task adherence, formality level, and helpfulness or clarity. The plurality of behaviors may comprise or consist of all of these governance behaviors and/or human-like behaviors, any subset of these governance behaviors and/or human-like behaviors, any subset of these governance behaviors and/or human-like behaviors with one or more other governance behaviors, human-like behaviors, and/or behaviors from other categories of behaviors, or other governance behaviors, human-like behaviors, and/or behaviors from other categories of behaviors that are not specifically mentioned herein.

Prompt generator 320 and embedding service 340 may be executed iteratively for each of the plurality of behaviors. These iterations may be executed in parallel or serially. For instance, if speed is prioritized, at least some, if not all, of the iterations may be executed in parallel. On the other hand, if there are limits on computational resources, at least some, if not all, of the iterations may be executed serially to prevent profiling engine 116 from exceeding those computational limits.

For each of the plurality of behaviors, prompt generator 320 may generate a prompt 325 for the behavior from at least a portion of agent data 315. In particular, prompt generator 320 may incorporate data, relevant to the behavior, from agent data 315, into a predefined template to generate prompt 325, which may comprise or consist of a natural-language expression. Prompt generator 320 may also incorporate an instruction, specific to the behavior, into the predefined template. The predefined template may comprise a pre-conversation and/or post-conversation, which provide context and/or instructions for AI model 330, and one or more placeholders into which the extracted data are inserted. The pre-conversation and/or post-conversation may define the role of the AI model 330 (e.g., to generate a summary of the nature of the specified behavior), define an output format (e.g., a natural-language summary), and/or the like. Prompt 325 is input to the AI model 330 to produce a response from AI model 330 (e.g., according to the output format defined by prompt 325). It is generally contemplated that AI model 330 is a generative language model, such as a large language model or a small language model. This generative language model may be fine-tuned to generate summaries of behaviors of AI agents 160.

It should be understood that prompt 325 will differ for each of the plurality of behaviors. For example, prompt 325 for two different behaviors may differ in terms of the relevant data that are used and the instruction for AI model 330. As an example, for the governance behavior of data sensitivity guardrails, the relevant data may comprise the agent definition for AI agent 160 (e.g., in JavaScript Object Notation (JSON) format), and the instruction may be to list the data-handling policies enforced by AI agent 160. For the governance behavior of regulatory scope, the relevant data may comprise prompts used by the orchestration layer of AI agent 160, and the instruction may be to summarize all compliance frameworks (e.g., General Data Protection Regulation (GDPR), Health Insurance Portability and Accountability Act (HIPAA), etc.) referenced in the relevant data. For the governance behavior of allowed tool surface, the relevant data may comprise the registry of tools 164 used by AI agent 160, and the instruction may be to describe the tools 164 and application programming interface that may be called by AI agent 160. For the governance behavior of safety alignment, the relevant data may comprise the conversation history for AI agent 160, and the instruction may be to rate the adherence by AI agent 160 to its refusal policy on disallowed content. For the human-like behavior of tone and empathy, the relevant data may comprise the conversation history, and the instruction may be to summarize the tone and/or empathy within the conversation history. For the human-like behavior of task adherence, the relevant data may comprise the conversation history, and the instruction may be to summarize how AI agent 160 reacts to prompts that seek to divert the AI agent 160 from the task (e.g., the conversation history in this case may comprise synthetic diversion prompts). For the human-like behavior of formality level, the relevant data may comprise style descriptors in the design-time system prompts, and the instruction may be to summarize the formality level based on the style descriptors. For the human-like behavior of helpfulness or clarity, the relevant data may comprise user feedback (e.g., post-interaction user surveys), and the instruction may be to summarize the helpfulness and/or clarity of AI agent 160 based on the user feedback.

Profiling service 116 applies AI model 330 to prompt 325, generated by prompt generator 320, to generate a summary 335 of the behavior for AI agent 160, according to the relevant data and the instruction in prompt 325. AI model 330 may be a generative language model, such as a large language model or small language model. AI model 330 produces summary 335 in response to prompt 325. Summary 335 may comprise a summary of the nature of the behavior (e.g., how the behavior manifests in AI agent 160), represented in the instruction in prompt 325, of AI agent 160. Summary 335 may comprise a concise, structured, natural-language description of the nature of the behavior. As a simple example, prompt 325 may comprise an instruction to “summarize all regulatory frameworks referenced by this AI agent,” and summary 335 may comprise a summary of all the regulatory frameworks referenced in agent data 315.

Embedding service 340 converts summary 335 into an embedding vector 345 that represents the semantic meaning of summary 335 within a vector space having a plurality of dimensions. Embedding vector 345 comprises a vector of real numbers, with each real number representing a position of summary 335 within a different dimension of the plurality of dimensions of the vector space. Each embedding vector 345 may be dense (i.e., most dimensions have non-zero values). It should be understood that each embedding vector 345 will have a length equal to the number of dimensions within the vector space. In practice, the vector space may comprise a hundred or more dimensions, and preferably hundreds of dimensions. In a particular implementation, the vector space consisted of seven-hundred-sixty-eight dimensions. The vector space represents the universe of semantic meaning, and the position of embedding vector 345 within the vector space represents the semantic meaning of summary 335 within the universe of semantic meaning. Advantageously, because embedding vector 345 is derived from a canonical, AI-curated summary 335, embedding vector 345 is both semantically rich and directly comparable across other AI agents 160 and time.

Embedding service 340 may convert each summary 335 into an embedding vector 345 in an identical manner. In other words, the embedding vector 345 for each of the plurality of behaviors belongs to the same vector space as every other embedding vector 345 for every other one of the plurality of behaviors. That is, all behaviors are embedded into the same vector space.

Any suitable contextual embedding model may be used by embedding service 340 to convert each summary 335 into an embedding vector 345. For example, the contextual embedding model may comprise any suitable deep-learning artificial neural network (e.g., using Long Short-Term Memory (LSTM) for context-awareness) or transformer (e.g., open-weight transformer). Examples of suitable embedding models include, without limitation, Bidirectional Encoder Representations from Transformers (BERT), as disclosed in J. Devlin et al., “BERT: Pre-training of Deep Bidirectional Transformers for Language Understanding,” arXiv: 1810.04805, which is hereby incorporated herein by reference as if set forth in full, or any of its extensions, such as Robustly Optimised BERT pretraining Approach (ROBERTa), ROBERTa-Large, A Lite BERT (ALBERT), Distilled BERT (DistilBERT), StructBERT, SpanBERT, Decoding-enhanced BERT with disentangled Attention (DeBERTa), Efficiently Learning an Encoder that Classifies Token Replacements Accurately (ELECTRA), Sentence-BERT (SBERT), Language-agnostic BERT Sentence Embeddings (LaBSE), multilingual BERT (mBERT), and the like. Additional examples of suitable embedding models include, Embeddings from Language Models (ELMo), Context Vectors (CoVe), Universal Sentence Encoder (USE), Simple Contrastive Sentence Embeddings (SimCSE), Instructor Embeddings, Cross-lingual Language Model (XLM), Language-Agnostic Sentence Representations (LASER), the text embedding models provided by OpenAI, Cohere Embed models, Anthropic Claude embeddings, Google Vertex AI embeddings, and the like.

Embedding service 340 adds embedding vector 345 to an agentic behavioral profile 350 comprising or consisting of a set of behavior-specific embedding vectors 345 for AI agent 160. It should be understood that over the plurality of iterations for the plurality of behaviors, agentic behavioral profile 350 will come to contain an embedding vector 345 for each of the plurality of behaviors. As a result, the number of embedding vectors 345 in agentic behavioral profile 350 will be equal to the number of the plurality of behaviors. Agentic behavioral profile 350 represents the semantic meanings of all summaries 335, which represent the natures of all of the plurality of behaviors. Advantageously, agentic behavioral profile 350 unifies heterogenous attributes of AI agent 160 (e.g., from static metadata and conversation history) into a single analyzable object.

Profiling service 116 may add each of embedding vectors 345 in agentic behavioral profile 350 to vector database 118, which may be stored in database 114. In other words, the semantic meaning of summary 335 for each of the plurality of behaviors for AI agent 160 is stored in vector database 118. Each embedding vector 345 that is stored in vector database 118 may be tagged with a unique identifier of AI agent 160 whose behavior it represents. Thus, when an embedding vector 345 is returned in a search of vector database 118, the AI agent 160 whose behavior is represented by that embedding vector 345 can be easily identified and/or retrieved from a registry of AI agents 160 by the associated agent identifier. Each embedding vector 345 that is stored in vector database 118 may also be tagged with a taxonomic behavior identifier of the behavior that the embedding vector 345 represents. In this case, when an embedding vector 345 is returned in a search of vector database 118, the behavior that it represents can be easily identified.

Notably, each embedding vector 345 in agentic behavioral profile 350 for AI agent 160 is stored separately and independently from the other embedding vectors 345 in agentic behavioral profile 350 for AI agent 160. In other words, the embedding vectors 345 in agentic behavioral profile 350 are not concatenated into a single composite vector, which would lose explainability for similarity matching. Storing one embedding vector 345 per behavior, within vector database 118, enables fast, explainable similarity searching, clustering, and policy analysis across large registries of AI agents 160, using standard vector search techniques.

Over the operation of profiling service 116, vector database 118 will acquire agentic behavioral profiles 350 for a plurality of AI agents 160, and preferably, every AI agent 160 that is available within computing environment 150 and/or registered within one or more registries of AI agents 160 (e.g., stored in database 114 of platform 110). An end client 360 may search vector database 118 by submitting a query 365 to a search engine 370 that has access to vector database 118. Query 365 may comprise a natural-language expression.

End client 360 may be a user (e.g., via user system 130) or a software entity (e.g., within computing environment 150 or via third-party system 140). When end client 360 is a user, end client 360 may submit query 365 via a user interface, such as a graphical user interface, of search engine 370. When end client 360 is a software entity, end client 360 may submit the query via an application programming interface of search engine 370. Search engine 370 could be an AI agent 160. In this case, search engine 370 may receive query 365 via agentic interface 165, which may comprise a user interface and/or application programming interface. Alternatively, in an embodiment in which search engine 370 is a module of server application 112, search engine 370 may receive query 365 via an interface of server application 112 (e.g., user interface 115 and/or an application programming interface (not shown) of server application 112).

At a high level, search engine 370 receives query 365 from end client 360. Search engine 370 searches vector database 118, based on query 365, to produce a search result 375. Search result 375 may comprise one or more agent identifiers. Each agent identifier identifies one of a plurality of AI agents 160 represented in vector database 118. Alternatively or additionally, search result 375 may comprise other data, retrieved for each of the AI agents 160 that is identified by one of the agent identifier(s) (e.g., using that agent identifier as an index). Finally, search engine 370 may return search result 375 to end client 360 in response to query 365.

Query 365, which may be a natural-language query, may identify one or more AI agents 160 and/or define one or more behaviors, as well as comprise one or more desired similarity criteria and/or weights. Search engine 370 may convert or decompose query 365 into one or more vector-database queries that comprise at least one input embedding vector 345 for each identified AI agent and/or defined behavior. In the event that search engine 370 must generate an input embedding vector 345 (e.g., from a defined behavior), search engine 370 may utilize the same embedding service 340, as profiling service 116, to generate the input embedding vector 345. Each input embedding vector 345 is defined in the same vector space as the reference embedding vectors 345, stored in vector database 118. Thus, it should be understood that each input embedding vector 345 will have the same number of dimensions (e.g., seven-hundred-sixty-eight dimensions) as each of embedding vectors 345 in each agentic behavioral profile 350, which will be the same as the number of dimensions in the vector space.

Search engine 370 may execute each vector-database query against vector database 118 (e.g., using an application programming interface of vector database 118) to find one or more reference embedding vectors 345, stored within vector database 118, that are sufficiently similar to the input embedding vector 345 within the vector-database query, according to one or more similarity criteria. Vector database 118 represents the entire universe of semantic meaning, and the position, defined by each reference embedding vector 345, represents the semantic nature of the associated behavior, for an AI agent 160, within that universe. The position, defined by the input embedding vector 345, represents the semantic meaning of a behavior, defined in query 365, within that universe. The input embedding vector 345, representing the vector-database query, may be compared to the reference embedding vectors 345 in vector database 118, according to a similarity metric. The similarity metric may be based on a distance (e.g., Euclidean distance, Manhattan distance, cosine distance, Hamming distance, Minkowski distance, Chebyshev distance, Jaccard distance, Haversine distance, Sorensen-Dice distance, etc.) between embedding vectors 345, with smaller distances representing more similarity and larger distances representing less similarity. The search of vector database 345 may be performed using any suitable technique, such as brute force, k-dimensional trees, ball trees, locality-sensitive hashing (LSH), k-nearest neighbor (kNN), approximate nearest neighbor (e.g., Facebook™ AI Similarity Search, Approximate Nearest Neighbors Oh Yeah (ANNOY), scalable nearest neighbors (ScaNN), etc.), Hierarchical Navigable Small World (HNSW) graphs, Inverted File Indexing (IVF), Voronoi diagrams, vector quantization, product quantization (PQ), random projection trees, lattice-based methods (e.g., cover tree, vantage point tree, etc.), and/or the like. In one example embodiment, HNSW graphs are used for the search, with cosine similarity (e.g., one minus the cosine distance) as the similarity metric. The similarity criteria for determining whether or not a reference embedding vector 345 matches the input reference embedding vector 345 may comprise determining whether or not the similarity metric between the two embedding vectors 345 satisfies (e.g., is equal to or greater than, or less than) a threshold (e.g., representing that the distance between the two embedding vectors 345 is less than or equal to a threshold, or greater than a threshold, respectively).

The search of vector database 118 will return an identifier of each AI agent 160 whose behavior matches the behavior represented in each vector-database query. In the event that there are a plurality of vector-database queries, search engine 170 may aggregate (e.g., union, intersection, difference, etc.) the search results, in the manner required to respond to query 365, to produce a final set of matching reference embedding vectors 345. As mentioned elsewhere herein, each of the reference vector embeddings 345, in vector database 118, may be tagged with an agent identifier of the corresponding AI agent 160. Search engine 370 may extract the agent identifiers from the tags of the matching reference embedding vectors 345, and incorporate the extracted agent identifiers, potentially with other relevant information about the identified AI agent(s) 160 (e.g., extracted from metadata associated with the identified AI agent(s) 160 in a registry of AI agents 160) into a search result 375. Search engine 345 may return search result 375 to end client 360 in response to query 365.

In an embodiment, query 365 may define one or more behaviors and specify at least one similarity criterion for each defined behavior. In this case, search engine 370 may generate a vector-database query, for each defined behavior, comprising an input embedding vector 345 for the defined behavior and each similarity criterion for that defined behavior. In particular, search engine 370 may search for reference vector embeddings 345, within vector database 118, that satisfy the one or more similarity criteria with respect to the input vector embedding 345. A defined behavior may be a specific one of the plurality of behaviors, a subset of the plurality of behaviors (e.g., an entire category of behaviors, such as all governance behaviors or all human-like behaviors), or all of the plurality of behaviors (i.e., the overall behavior). Search engine 370 may aggregate the vector-database queries, if necessary, to produce a final set of matching reference embedding vectors 345, and then retrieve the agent identifier associated with each reference embedding vector 345 (e.g., from the tag(s) associated with each matching reference embedding vector 345) in the final set of matching reference embedding vectors 345. Search engine 370 may then return a search result 375, comprising each retrieved agent identifier and/or data derived from each retrieved agent identifier, to end client 360 in response to query 365. In summary, search engine 170 may search vector database 118, based on query 365, to produce search result 375 by, for each of the one or more defined behaviors, generating an input embedding vector 345 representing the defined behavior, generating a vector-database query that queries vector database 118 for matching reference embedding vectors 345 that are similar, according to one or more similarity criteria, to the input embedding vector 345, and executing the vector-database query to retrieve any matching reference embedding vectors 345, and then determining a final set of matching reference embedding vectors 345, and adding an agent identifier associated with each of the matching reference embedding vectors 345, in the final set, to search result 375.

As an example, end client 360 may submit a query 365 comprising “find agents with >0.95 composite similarity.” This query 365 may be useful in identifying redundant AI agents 160. In this example, the defined behavior is all of the plurality of behaviors (i.e., “composite similarity”) and the similarity criterion is “>0.95 composite similarity.” Search engine 370 may execute a clustering algorithm that finds AI agents 160 whose agentic behavioral profiles 350, as represented by sets of reference embedding vectors 345 in vector database 118, have a composite similarity metric that is greater than 0.95 (e.g., 0.95-1.0). It should be understood that a composite similarity metric is an aggregation (e.g., average, weighted average, median, etc.) of the similarity metrics for each of the plurality of behaviors represented in agentic behavioral profiles 350. In other words, the composite similarity metric between a pair of AI agents 160 may be computed by, for each of the plurality of behaviors, calculating the similarity metric between the pair of reference embedding vectors 345 representing that behavior for the pair of AI agents 160, and then aggregating the similarity metrics calculated for all of the plurality of behaviors. In an alternative example, query 365 may specify a similarity criterion with respect to a particular behavior (e.g., “>0.95 similarity in guardrails”), in which case search engine 370 may execute a clustering algorithm that finds AI agents 160 whose data sensitivity guardrails are greater than 0.95 in terms of the similarity metric relative to each other. In any case, search engine 370 may return a search result 375, comprising the agent identifier for all AI agents 160 within the cluster of similar AI agents 160, to end client 360 in response to query 365. End client 360 could use search result 375 to identify redundant or duplicate AI agents 160, and potentially prune one or more of the identified redundant AI agents 160 (e.g., remove them from computing environment 150 and/or the registry of AI agents 160).

As another exemplary use case, search engine 370 may be used for policy-compliant recommendations. For instance, end client 360 may submit a query 365 comprising “filter agents>0.9 on HIPAA compliance, then rank by empathy.” This query 365 may represent a search for a list of AI agents 160 that are healthcare chatbots, ranked by their ability to empathize with their users. In this case, “>0.9 similar on HIPAA compliance” represents a defined behavior with a similarity criterion. Search engine 370 may convert “HIPAA compliance” into a first input embedding vector 345, and search vector database 118 using a first vector-database query that selects reference embedding vectors 345 that have a similarity metric, with respect to the first input embedding vector 345, that is greater than 0.9, to produce a first query result. In parallel, search engine 370 may convert “empathy” into a second input embedding vector 345 (e.g., representing the semantic meaning of “high degree of empathy and supportive tone,” based on the intent of query 365), and search vector database 118 using a second vector-database query that selects reference embedding vectors 345 that have a similarity metric, with respect to the second input embedding vector 345, that is greater than a threshold (e.g., 0.9) representing a high degree of similarity, to produce a second query result. Search engine 370 may then retrieve the associated agent identifiers from each of the first and second query results, and cross-reference them to produce a final set of agent identifiers that are in both the first and second query results. Each of the agent identifiers in the final set represents an AI agent 160 that is HIPAA compliant and possesses a high level of empathy. Search engine 370 may generate a search result 375, comprising the agent identifier for all AI agents 160 within the final set, in descending order of their respective similarity metrics for empathy in the second query result, and return this search result 375 to end client 360 in response to query 365.

In an embodiment, query 365 may identify one or more AI agent 160, and search engine 370 may utilize one or more behaviors of the identified AI agent(s) 160 to find behaviorally similar AI agents 160, using vector database 118. In this case, search engine 370 may retrieve one or more reference vector embeddings 345, within the agentic behavioral profile 350 of the identified AI agent(s) 160, for the behavior(s) implicated by query 365. In the event that no behaviors are defined in query 365, all of the reference vector embeddings 345, in the agentic behavioral profile 350 of each of the identified AI agent(s) 160, may be retrieved. Otherwise, if one or more behaviors are defined in query 365, only the reference vector embedding(s) 345 for the defined behavior(s) may be retrieved. Search engine 370 may then search vector database 118 for reference embedding vectors 345 that satisfy one or more similarity criteria with respect to the retrieved embedding vectors 345 for the specified AI agent(s) 160. In the event that no similarity criteria are defined in query 365, search engine 370 may search vector database 118 for reference embedding vectors 345 that are most similar to the retrieved embedding vectors 345 in the agentic behavioral profile 350 of the identified AI agent(s) 160, or that satisfy one or more default similarity criteria with respect to the retrieved embedding vectors 345 in the agentic behavioral profile(s) 350 of the identified AI agent(s) 160. Search engine 370 may incorporate the agent identifier(s) of any reference AI agents 160 that satisfy query 365 into search result 375, and return search result 375 to end client 360 in response to query 365. Such a search may be useful for identifying best-fit alternatives to a given AI agent 160. In summary, when query 365 identifies one or more input AI agents 160, search engine 370 may search vector database 118 based on query 365 to produce search result 375 by, for each of the one or more input AI agents 160, retrieve at least one embedding vector 345 for the input AI agent 160 from vector database 118, generate a vector-database query that queries vector database 118 for matching reference embedding vectors 345 that are similar, according to one or more similarity criteria, to the at least one embedding vector 345, and execute the vector-database query to retrieve any matching reference embedding vectors 345, determine a final set of matching reference embedding vectors 345; and add an agent identifier associated with each of the matching reference embedding vectors 345, in the final set, to search result 375.

As an example, end client 360 may submit a query 365 comprising “find agents>0.9 similar on guardrails to Agent Q but <0.5 similar on tone.” This query 365 represents a search for an AI agent 160 with the same safety posture but a different writing style, and may be useful for a governance audit. In this case, Agent Q is the specified AI agent 160, and “>0.9 similar on guardrails” and “<0.5 similar on tone” are similarity criteria for the defined behaviors of guardrails and tone, respectively. Search engine 370 may retrieve a first embedding vector 345 associated with the governance behavior of data sensitivity guardrails for Agent Q and a second embedding vector 345 associated with the human-like behavior of tone and empathy for Agent Q, from vector database 118. Search engine 370 may decompose query 365 into a first vector-database query that searches vector database 118 for reference embedding vectors 345, associated with other AI agents 160, with a similarity metric that is greater than 0.9 to the first retrieved embedding vector 345, and a second vector-database query that searches vector database 118 for reference embedding vectors 345, associated with other AI agents 160, with a similarity metric of less than 0.5 to the second retrieved embedding vector 345. Search engine 370 may then aggregate these results using an intersection of the two sets of reference embedding vectors 345 based on the AI agents 160 with which they are associated. In other words, search engine 370 will identify AI agents 160 whose behaviors are present in the search results of both the first and second vector-database queries. Search engine 370 may return the agent identifiers of these AI agents 160 in search result 375 to end client 360 in response to query 365.

As another exemplary use case, search engine 370 could be used for risk detection by identifying and flagging AI agents 160 that are outliers in terms of one or more behaviors. For example, search engine 370 could search for AI agents 160 for which a single behavior, subset of two or more behaviors, or all behaviors are outliers with respect to any other AI agents 160. It should be understood that an outlying behavior is one for which the similarity metric, between the reference embedding vector 345, representing that behavior for the outlying AI agent 160, and the nearest other reference embedding vector 345, representing that same behavior for another AI agent 160, is very low (e.g., is less than a threshold), indicating high behavioral dissimilarity from any other AI agent 160. Thus, given agentic behavioral profiles 350 for a very large number of AI agents 160, search engine 370 can apply one or more clustering algorithms to identify and flag outlying AI agents 160 for subsequent review and analysis (e.g., by a human user or analytical software). Outlying AI agents 160 may represent security threats or wasted computational resources, and once identified, may be removed from service, for example, by automatically (i.e., without human involvement), semi-automatically (e.g., by prompting a human user, and receiving a confirmation from the human user), or manually (e.g., via notification to a human user, who may take action upon notification) un-deploying any outlying AI agent 160 from computing environment 150 and/or removing or suspending any outlying AI agent 160 from a registry of AI agents 160.

It should be understood that, in some cases, no results may be returned by a vector-database query and/or the aggregation of two or more vector-database queries may result in no reference embedding vectors 345. In this case, search engine 370 may return an empty (e.g., null) search result 375 (e.g., comprising no agent identifiers) or may otherwise indicate the absence of any matching AI agents 160.

As another exemplary use case, search engine 370 could be used to compare two or more AI agents 160. For example, query 365 may identify two or more AI agents 160, and optionally one or more behaviors, to be compared. If no behavior is identified, search engine 370 may retrieve the entire agentic behavioral profile 350 for each identified AI agent 160. Otherwise, if one or more behaviors are identified, search engine 370 may retrieve the reference embedding vector(s) 345, within the agentic behavioral profile 350 for each identified AI agent 160, representing the identified behavior(s). In either case, search engine 370 may, for each behavior for which a reference embedding vector 345 is retrieved, calculate a similarity metric between the retrieved embedding vectors 345 for that behavior for the identified AI agents 160. Search engine 370 may return a search result 375, comprising the value of the similarity metric for each identified behavior, to end client 360 in response to query 365. Thus, the behavioral similarity of two or more AI agents 160 may be quantified for end client 360.

Search engine 370 is not limited to only searching for AI agents 160 based on behaviors represented in vector database 118. For example, search engine 370 may search vector database 118 for any reference embedding vectors, stored in vector database 118, regardless of what they represent (i.e., behaviors or otherwise). In addition, search engine 370 may search other databases, including potentially one or more data sources 310, including metadata from a registry of AI agents 160. In any case, searching the behaviors of AI agents 160, represented in vector database 118, may be used as one component in a search for, or otherwise related to, AI agents 160. As an example, a general search for AI agents 160 in a registry may be augmented by biasing search results 375 towards or away from one or more behaviors. In particular, one or more behaviors for AI agents 160, found in a general search, may be retrieved from vector database 118 and used to weight, filter, rank, or prioritize the AI agents 160 in search results 375. For instance, in an example of a policy-based weighting, a search performed by a user, who is responsible for cybersecurity within an organization, may be biased towards compliance-related behaviors (e.g., data sensitivity guardrails, regulatory scope, safety alignment, etc.).

To formalize disclosed embodiments, the embedding vector 345 for a behavior may be denoted by b. In this case, agentic behavioral profile 350 for an AI agent 160 can be expressed as:

$$ABP ( A ) = \{ {b}_{1} , {b}_{2} , ... , {b}_{n} \} , {b}_{i} ∈ {ℝ}^{b}$$

wherein ABP is agentic behavioral profile 350, A is a first AI agent 160, [symbol] represents the plurality of behaviors represented in agentic behavioral profile 350, and n is the total number of behaviors in the plurality of behaviors [symbol] . The plurality of behaviors [symbol] may include one or more governance behaviors, one or more human-like behaviors, and/or one or more other categories of behaviors. Each of vectors bᵢ have the same dimensionality (e.g., seven-hundred-sixty-eight dimensions in an exemplary implementation).

Notably, the plurality of behaviors [symbol] are easily extensible. In particular, to add a new behavior to the plurality of behaviors [symbol] , a new instruction simply needs to be provided to prompt generator to instruct AI model 330 to summarize the new behavior, and then profiling service 116 needs to be executed for each new behavior and each AI agent 160 for which the new behavior is to be represented (e.g., every AI agent 160 in computing environment 150 and/or a registry of AI agents 160). Each resulting embedding vector 345 may be tagged with an agent identifier of the respective AI agent 160, an identifier of the behavior, and/or other data, and added to vector database 118. Advantageously, none of the existing reference embedding vectors 345, in vector database 118, need to be re-encoded or otherwise modified, and no model retraining is required. In other words, the only modification that may be required to the infrastructure is to provide a new behavior-specific instruction to prompt generator 320 for each new behavior, to be used for generating prompts 325 for the new behavior(s). Thus, behaviors can be added and removed in a modular manner, simply by adding or removing available instructions to or from prompt generator 320.

In an embodiment, the similarity metric between two embedding vectors 345, for behavior bᵢ, may be a cosine similarity:

$${sim}_{{b}_{i}} ( A , B ) = cos ( {b}_{i}^{( A )} \cdot {b}_{i}^{( B )} )$$

wherein A is the first AI agent 160, B is a second AI agent 160, sim_{b}_{ᵢ} is the similarity metric for behavior bᵢ, cos is the cosine similarity function, bᵢ^{(A)} is the embedding vector 345 for the first AI agent 160, and bᵢ^{(B)} is the embedding vector 345 for the second AI agent 160. The cosine similarity function calculates the cosine of the angle between the embedding vectors 345 for the first and second AI agents 160.

In an embodiment, a composite similarity metric may be calculated for a set of two or more of the plurality of behaviors. This set may consist of a subset of the plurality of behaviors or all of the plurality of behaviors. The composite similarity metric may be calculated as:

$${sim}_{b} ( A , B ) = \frac{{\sum }_{i = 0}^{k} {w}_{{b}_{i}} \cdot {sim}_{{b}_{i}} ( A , B )}{{\sum }_{i = 0}^{k} {w}_{{b}_{i}}}$$

$$1 < k \leq n$$

wherein sim_{b}(A, B) is the composite similarity metric for the set of behaviors between the first and second AI agents 160, w_{b}_{ᵢ} is a weight for behavior bᵢ, and k is the number of behaviors in the set of behaviors. It should be understood that if k=n, then the composite similarity metric is an overall similarity metric for all behaviors in the plurality of behaviors [symbol] (i.e., all behaviors in each agentic behavioral profile 350).

The weights w may all be set to one by default or in an unweighted implementation. Otherwise, in a weighted implementation, the weights w may represent the relative importance of the respective behaviors to the composite similarity metric. These weights w may be set in query 365. For example, end client 360 could specify, in query 365, a weight for each of one or more behaviors. All of the other behaviors in the set of behaviors b₁, b₂, . . . , bₖ may be set to one or other default value. In other words, in this embodiment, each weight w is configurable in query 365.

As some potential examples, a composite similarity metric could be calculated for all of the plurality of behaviors [symbol] (i.e., k=n) to a generative an overall similarity score, for only the governance behaviors to generate a composite governance score, for only the human-like behaviors to generate a composite human-like score, and/or for any other category or group of categories of behaviors to generate a composite category-specific score. Alternatively, a composite similarity metric could be calculated for any combination of behaviors of interest, regardless of specific behavioral categories.

### 4. PROFILING PROCESS

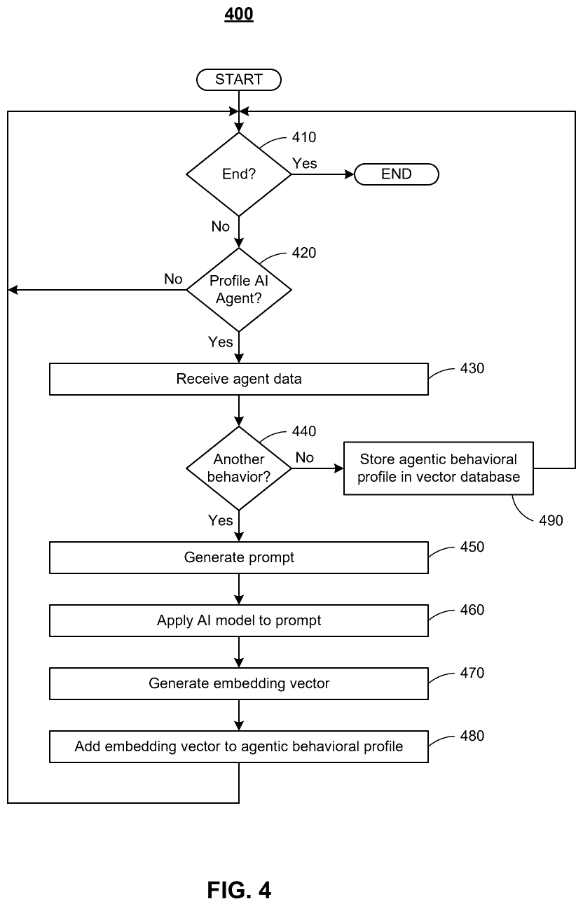

FIG. 4 illustrates an example process 400 for the behavioral profiling of artificial intelligence (AI) agents using a multi-dimensional vector framework, according to an embodiment. Process 400 may be implemented by profiling service 116, which may be a software module of server application 112 or a separate software entity, including potentially, an AI agent 160 that utilizes one or more models 162 and one or more tools 164. While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 410 may determine whether or not to end process 400. Process 400 may continue for as long as profiling service 116 is operational, and end when the operation of profiling service 116 is terminated. When determining to end process 400 (i.e., “Yes” in subprocess 410), process 400 may end. Otherwise, when not determining to end process 400 (i.e., “No” in subprocess 410), process 400 may proceed to subprocess 420.

Subprocess 420 may determine whether or not a profiling request to profile an AI agent 160 has been received. The profiling request may trigger profiling service 116 to process AI agent 160. A profiling request may be generated in response to any suitable trigger, such as the deployment of a new AI agent 160 or new version of an existing AI agent 160 to computing environment 150, the addition of a new AI agent 160 or new version of an existing AI agent 160 to a registry (e.g., stored in database 114) of AI agents 160, the expiration of a time interval that triggers the profiling of a new batch of AI agents 160 (e.g., all new AI agents 160 since the last batch), the operation of an end client (e.g., a user operation by a human user via a graphical user interface of profiling service 116, an automated operation by a software entity via an application programming interface of profiling service 116, etc.), and/or the like. The profiling request may comprise an agent identifier of the AI agent 160 to be profiled. When determining that a new profiling request has been received (i.e., “Yes” in subprocess 420), process 400 may proceed to subprocess 430. Otherwise, while not determining that a new profile request has been received (i.e., “No” in subprocess 420), process 400 may return to subprocess 410.

Subprocess 430 may receive agent data 315 for the AI agent 160 to be profiled. Agent data 315 may be sent with the profiling request, received in subprocess 420, along with the agent identifier, or may be sent separately from the profiling request. Alternatively, the profiling request may comprise an agent identifier, and profiling service 116 may retrieve agent data from one or more data sources 310 based on the agent identifier (e.g., using the agent identifier as an index).

Agent data 315 may comprise metadata for AI agent 160 and/or a conversation history for AI agent 160. The metadata may comprise any relevant information that is collected about AI agent 160. In an embodiment, the metadata may be retrieved from a registry of AI agents 160 for platform 110 and/or computing environment 150. Metadata may be human-authored in natural language and/or automatically generated by a software entity (e.g., a monitoring service). The conversation history may comprise a transcript of each of one or more sessions between an end client and AI agent 160, a summary (e.g., natural-language summary) of each of one or more sessions between an end client and AI agent 160, and/or the like.

Subprocess 440 may determine whether or not another behavior (i.e., b;), from among a plurality of behaviors (i.e., [symbol] ), remains to be profiled. In other words, an iteration of subprocesses 450-480 is executed for each of the plurality of behaviors. These iterations may be performed in parallel and/or serially, by design or depending on one or more factors (e.g., available computational resources, limits on computational time, load on profiling service 116, etc.). When determining that another behavior remains to be profiled (i.e., “Yes” in subprocess 440), process 400 may select the next unprofiled behavior, from among the plurality of behaviors, and proceed to subprocess 450. Otherwise, when determining that no more behaviors remain to be profiled or that all of the plurality of behaviors have been profiled (i.e., “No” in subprocess 440), process 400 may proceed to subprocess 490.

Subprocess 450, which may be implemented by prompt generator 320, may generate prompt 325 for the selected behavior from at least a portion of agent data 315. In particular, prompt generator 320 may extract at least a portion of agent data 315 that is relevant to the selected behavior. Prompt generator 320 may also select a behavior-specific instruction that is associated with the selected behavior, from among a plurality of behavior-specific instructions. It should be understood that the plurality of behavior-specific instructions may comprise at least one instruction for each of the plurality of behaviors. The behavior-specific instruction may be to summarize the nature of the selected behavior. Prompt generator 320 may incorporate the extracted relevant data and the behavior-specific instruction into a template, which may comprise pre-conversation and/or post-conversation, to produce prompt 325. Prompt 325 may comprise or consist of a natural-language expression.

Subprocess 460 may apply AI model 330 to the prompt 325 that was generated in subprocess 450. In an embodiment, AI model 330 is a generative language model, and in a particular limitation, a large language model. AI model 330 accepts prompt 325 as input, and outputs a summary 335 of the nature of the selected behavior. Summary 335 may comprise or consist of a natural-language expression, and particularly, a concise, structured, natural-language description of how the behavior manifests in AI agent 160, based on the relevant data provided in prompt 325. Essentially, AI model 330 represents an intelligent evaluation layer that ingests heterogenous agent data 315 for AI agent 160, and outputs a rich textual summary 335 of an observed behavior in AI agent 160.

Subprocess 470 may generate an embedding vector 345 for the selected behavior by converting summary 335, output by AI model 330 in subprocess 460, into an embedding vector 345 that represents a semantic meaning of summary 335 within the vector space of vector database 118. In particular, embedding service 340 may apply an embedding model, and preferably a contextual embedding model, to summary 335 to encode summary 335 into embedding vector 345, which represents an embedding of the semantic meaning of summary 335 within the vector space. The vector space may have at least one-hundred dimensions, and preferably multiple hundreds of dimensions (e.g., seven-hundred-sixty-eight dimensions). Each embedding vector 345 has a length equal to the number of dimensions of the vector space.

Subprocess 480 may add the embedding vector 345, generated in subprocess 470, to an in-progress agentic behavioral profile 350 for AI agent 160. It should be understood that, over iterations of subprocesses 440-480, an embedding vector 345 will be added to agentic behavioral profile 350 for each of the plurality of behaviors. Thus, once all of the plurality of behaviors have been profiled (i.e., “No” in subprocess 440), agentic behavioral profile 350 will comprise an embedding vector 345 for every one of the plurality of behaviors, representing a complete behavioral profile of AI agent 160.

Subprocess 490 may store the complete agentic behavioral profile 350 in vector database 118. In particular, profiling service 116 may add each of embedding vectors 345 in agentic behavioral profile 350, as a reference embedding vector 345, to vector database 118. Each embedding vector 345 may be associated, in vector database 118, with an agent identifier of AI agent 160 and/or a behavior identifier of the behavior of AI agent 160 that is represented by embedding vector 345. For example, embedding vector 345 may be tagged with, indexed by, and/or otherwise keyed by the agent identifier and/or behavior identifier. As a result, embedding vectors 345 are persistently stored in vector database 118, in a manner that enables ultra-fast similarity searches, clustering, and analytics (e.g., governance analytics) across the full landscape of AI agents 160.

### 5. SEARCH PROCESS

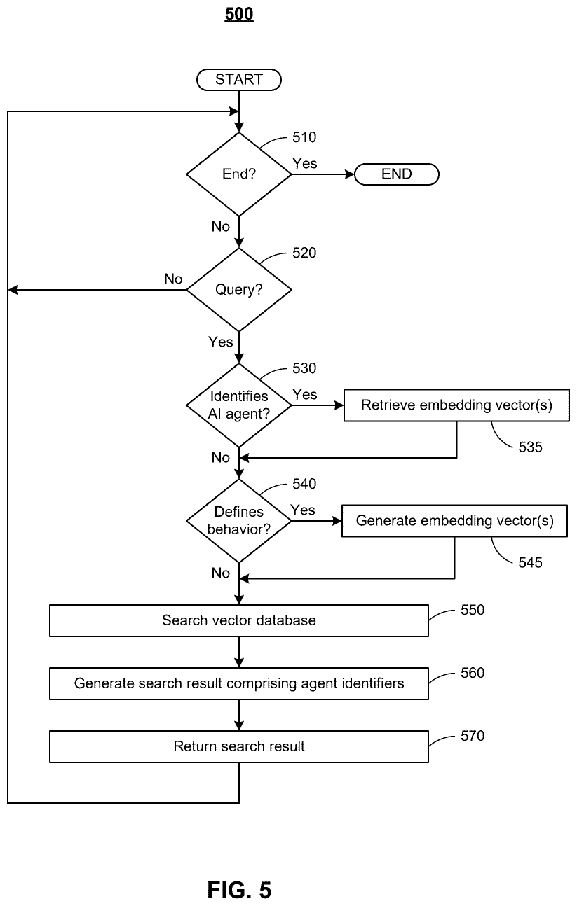

FIG. 5 illustrates an example process 500 for searching artificial intelligence (AI) agents using a multi-dimensional vector framework, according to an embodiment. Process 500 may be implemented by search engine 370, which may be a software module of server application 112 or a separate software entity, including potentially, an AI agent 160 that utilizes one or more models 162 and one or more tools 164. While process 500 is illustrated with a certain arrangement and ordering of subprocesses, process 500 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 510 may determine whether or not to end process 500. Process 500 may continue for as long as search engine 370 is operational, and end when the operation of search engine 370 is terminated. When determining to end process 500 (i.e., “Yes” in subprocess 510), process 500 may end. Otherwise, when not determining to end process 500 (i.e., “No” in subprocess 510), process 500 may proceed to subprocess 520.

Subprocess 520 may determine whether or not a query 365 has been received from an end client 360, which may be a human user or software entity. In the event that end client 360 is a user, query 365 may be received via a user interface, such as a graphical user interface, of search engine 370 or server application 112 (e.g., user interface 115). In the event that end client 360 is a software entity, query 365 may be received via an application programming interface of search engine 370 or server application 112. When determining that a query 365 has been received (i.e., “Yes” in subprocess 520), process 500 may proceed to subprocess 530. Otherwise, when not determining that a query 365 has been received (i.e., “No” in subprocess 520), process 500 may return to subprocess 510.

Subprocess 530 may determine whether or not query 365 identifies one or more AI agents 160. For example, in a use case, query 365 may request AI agents 160 that are similar or dissimilar, in each of one or more behaviors, to a specified AI agent 160. As another use case, query 365 may request a behavioral comparison of two or more identified AI agents 160. An AI agent 160 may be identified, in query 365, by an agent identifier, such as a unique numerical identifier, name, description, and/or the like of the AI agent 160. When detecting an agent identifier, subprocess 530 may determine that query 365 identifies an AI agent 160, and otherwise, may determine that query 365 does not identify any AI agents 160. When determining that query 365 identifies one or more AI agents 160 (i.e., “Yes” in subprocess 530), subprocess 530 may extract each agent identifier from query 365, and process 500 may proceed to subprocess 535. Otherwise, when determining that query 365 does not identify any AI agents 160 (i.e., “No” in subprocess 530), process 500 may proceed to subprocess 540.

Subprocess 535 may retrieve one or more reference embedding vector(s) 345, from vector database 118, for each AI agent 160 that was identified in query 365. For example, reference embedding vectors 345, in vector database 118, may be indexed by agent identifier, and subprocess 535 may retrieve at least a subset of the agentic behavioral profile 350 of each identified AI agent 160, using the agent identifier as an index. For each identified AI agent 160, the reference embedding vector(s) 345 that are retrieved may represent all of the reference embedding vectors 345 in agentic behavioral profile 350 or a subset of the reference embedding vectors 345 in agentic behavioral profile 350. In the latter case, the subset may comprise or consist of those reference embedding vector(s) 345 that represent behavior(s) that are pertinent to query 365.

Subprocess 540 may determine whether or not query 365 identifies one or more behaviors. For example, in a use case, query 365 may request AI agents 160 that are similar or dissimilar in terms of a behavior. Defined behaviors within query 365 may be detected using natural-language processing, potentially including a generative language model (e.g., large language model, small language model, etc.). A defined behavior may represent a single one of the plurality of behaviors or any combination of the plurality of behaviors, including potentially all of the plurality of behaviors (e.g., an overall behavioral similarity or dissimilarity). When determining that query 365 defines one or more behaviors (i.e., “Yes” in subprocess 540), process 500 may proceed to subprocess 545. Otherwise, when determining that query 365 does not define any behaviors (i.e., “No” in subprocess 540), process 500 may proceed to subprocess 550.

Subprocess 545 may extract the defined behavior(s) from query 365, and any similarity criteria and/or weights, defined in query 365, for the defined behavior(s). Subprocess 545 may then generate an embedding vector 345 for each extracted defined behavior, in the same manner that the reference embedding vectors 345, in vector database 118, were generated. In particular, search engine 370 may utilize embedding service 340 to generate an embedding vector 345 for each defined behavior in query 365. It should be understood that the embedding vector(s) 345, generated in subprocess 545, will represent a semantic meaning of the defined behavior within the vector space of vector database 118, and will have the same dimensions as each reference embedding vector 345 in vector database 118.

Subprocess 550 may search vector database 118 based on query 365. In particular, an orchestration layer of search engine 370 may convert or decompose query 365 into one or more, and in many cases a plurality of, vector-database queries. A vector-database query may utilize and/or otherwise be based on any of the embedding vectors 345 retrieved in subprocess 535 and/or generated in subprocess 545, as well as any similarity criteria and/or weights extracted from query 365. If query 365 specified any similarity criteria, one or more vector-database queries may incorporate one or more of these similarity criteria, for instance, by defining what represents a matching reference embedding vector 345 (e.g., a threshold for a similarity metric). Similarly, if query 365 specified any weights for one or more behaviors or default weights have been specified for one or more behaviors, one or more vector-database queries may incorporate one or more of these weights, for instance, by weighting a set of embedding vectors 345 representing behaviors. Search engine 370 may submit each vector-database query to vector database 118, for example, via an application programming interface of vector database 118. The application programming interface of vector database 118 may accept weighted vector-database queries that emphasize or de-emphasize any of the behaviors on demand. Each vector-database query will return a result of zero, one, or a plurality of reference embedding vectors 345 representing matching AI agents 160, identified by associated agent identifiers (e.g., within tags associated with each reference embedding vector 345).

In the event that query 365 is decomposed into a plurality of vector-database queries, any vector-database queries that are not dependent upon each other may be executed in parallel, whereas any vector-database query that depends on another vector-database query may be executed serially with that other vector-database query. Each vector-database query will return a respective result, representing matching AI agents 160, if any. These results may be aggregated by search engine 370 (e.g., by the orchestration layer of search engine 370), according to query 365, in any suitable manner (e.g., union, intersection, difference, etc.).

As an example, query 365 may comprise “find agents≥0.9 similar on HIPAA guardrails and ≥0.8 on empathy.” In this case, no AI agents are identified (i.e., “No” in subprocess 530), but two behaviors (e.g., HIPAA guardrails with a similarity criterion of ≥0.9, and empathy with a similarity criterion of ≥0.8) are defined (i.e., “Yes” in subprocess 540). Each of these behaviors may be converted into embedding vectors 345 in subprocess 545. For instance, “HIPAA guardrails” or an expanded summary (e.g., generated by AI model 330 or other generative language model, such as a small or large language model) may be converted into a first embedding vector 345, and “empathy” or an expanded summary (e.g., “high degree of empathy and supportive tone”) may be converted into a second embedding vector 345. Subprocess 550 may decompose query 365 into a first vector-database query that selects all reference embedding vectors 345, in vector database 118, that have a similarity metric (e.g., cosine similarity) of 0.9 or greater (e.g., 0.9-1.0) with the first embedding vector 345 generated for HIPAA guardrails, and a second vector-database query that selects all reference embedding vectors 345, within vector database 118, that have a similarity metric of 0.8 or greater (e.g., 0.8-1.0) with the second embedding vector 345 for empathy. Since the first and second vector-database queries are not dependent, search engine 370 may execute them in parallel. Vector database 118 will return (e.g., with sub-millisecond latency) a first set of reference embedding vectors 345, representing AI agents 160 with HIPAA guardrails, in response to the first vector-database query, and a second set of reference embedding vectors 345, representing AI agents 160 with high levels of empathy, in response to the second vector-database query. Search engine 370 may determine the intersection of these two sets of reference embedding vectors 345 to produce an intersecting set of reference embedding vectors 345, representing AI agents 160 with both HIPAA guardrails and a high level of empathy, and extract the agent identifiers (e.g., from tags) associated with this intersecting set. Search engine 370 may also perform any necessary post-processing, such as calculating per-behavior similarity metrics, applying policy filters to one or more behaviors, computing composite similarity metrics, normalizing results for explainability, and/or the like.

Subprocess 560 may generate search result 375, comprising the agent identifiers associated with the final set of matching reference embedding vectors 345. Each agent identifier represents an AI agent 160 that matches query 365. It should be understood that search result 375 may comprise other information, such as the similarity metric for each matching reference embedding vector 345 for each behavior defined in query 365, composite similarity metric(s), explanations (e.g., natural-language explanations) of why the AI agent(s) are matches, any of the tags or other data associated with the matching reference embedding vectors 345 and/or retrievable using the agent identifiers or other data associated with the matching reference embedding vectors 345, and/or the like. Search result 375 may be formatted into any suitable format, and will generally comprise at least a list of matching AI agents 160 (e.g., by name or other identifier), potentially with respective descriptions (e.g., natural-language descriptions) or other data (e.g., user feedback, one or more metrics, etc.) about each matching AI agent 160.

In an embodiment, the search results from the vector-database query(ies), aggregated if necessary by search engine 370, may be input to a generative language model, such as a large language model, to generate search result 375. In this case, search engine 370 may incorporate the search results, and potentially other relevant data, into a predefined template to generate a prompt, which may comprise or consist of a natural-language expression. The predefined template may comprise a pre-conversation and/or post-conversation, which provide context and/or instructions for the generative language model, and one or more placeholders into which the relevant data are inserted. The prompt may be input to the generative language model to produce search result 375, which may comprise or consist of a natural-language expression, including identifiers and/or descriptions of the matching AI agent 160, from the generative language model (e.g., according to the output format defined by the prompt).

Subprocess 570 may return search result 375 to end client 360. In the event that end client 360 is a user, search result 375 may be returned via a user interface, such as a graphical user interface, of search engine 370 or server application 112 (e.g., user interface 115). In the event that end client 360 is a software entity, search result 375 may be returned via an application programming interface of search engine 370 or server application 112. End client 360 may explore, audit, or otherwise act upon search result 375. For instance, if search result 375 identifies a redundant AI agent 160, an outlying AI agent 160, an AI agent 160 whose behavior violates one or more security policies, and/or the like, that AI agent 160 may be terminated (e.g., termination of any executing instances of the AI agent 160), suspended, un-deployed from computing environment 150, removed from a registry of AI agents 160, and/or the like.

### 6. EXAMPLE EMBODIMENT

As the number of AI agents 160 in operation has increased, it has become difficult to analyze and search registries of AI agents 160, especially in terms of comparisons between two or more AI agents 160. As a result, there is a proliferation of redundant AI agents 160, and it has become difficult to pinpoint policy gaps.

Accordingly, disclosed embodiments enable a holistic view of the behaviors of AI agents 160, including governance and/or human-like behaviors, both individually and in relation to the behaviors of other AI agents 160. In particular, profiling service 116 embeds each of a plurality of behaviors of each AI agent 160 into the same vector space by feeding heterogeneous data (e.g., metadata and/or conversation histories) about the AI agent 160 through AI model 330, converting the output of AI model 330 into an embedding vector 345, and storing the embedding vector 345 in vector database 118 in association with an agent identifier of AI agent 160 and/or behavior identifier. The behaviors that are embedded into the vector space may comprise governance behaviors, human-like behaviors, and/or any other category or categories of behaviors. Profiling engine 116 represents a scalable pipeline that converts heterogenous agentic data into a unified vector representation for downstream queries and audits.

Advantageously, because an embedding vector 345 is generated and stored for each individual behavior, the pipeline of profiling engine 116 is easily scalable to new behaviors. In particular, a new behavior can be modularly added by simply adding a new embedding vector 345, to vector database 118, representing that new behavior, for each AI agent 160. No existing embedding vectors 345, within vector database 118, need to be re-encoded or re-indexed.

In an embodiment, a search engine 370 is provided to search for AI agents 160 in response to behavior-based queries 365, to produce search results 375 that identify AI agents 160 with specific behaviors, comparable behaviors to other AI agents 160, redundant behaviors, outlying behaviors, violative behaviors, and/or the like. Similarity may be computed behavior-wise or as a composite score for a subset of behaviors or all behaviors. Advantageously, because search results 375 are based on similarity metrics between behaviors, search results 375 are easily explainable.

This closed loop of embedding and searching ensures that even complex governance-weighted searches remain transparent and scalable. Organizations may utilize vector database 118 to surface AI agents 160 that are governance-compatible for sensitive workloads. In addition, embodiments may be used to recommend AI agents 160 that exhibit specific interpersonal qualities (e.g., “find a highly empathetic, policy-compliant assistant”). In all cases, embodiments can provide (e.g., to an auditor) an explainable, behavior-level breakdown of why two AI agents 160 are similar or divergent. In summary, disclosed embodiments empower enterprises or other organizations to discover redundant AI agents 160, recommend best-fit alternatives to an AI agent 160, enforce governance with measurable and explainable confidence, and the like.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, by a profiling service:
receive agent data for an artificial intelligence (AI) agent;
for each of a plurality of behaviors,
generate a prompt for the behavior from at least a portion of the agent data,
apply a generative language model to the prompt to generate a summary of the behavior for the AI agent, and
convert the summary into an embedding vector that represents a semantic meaning of the summary within a vector space, and
add the embedding vector to an agentic behavioral profile for the AI agent; and
add each of the embedding vectors in the agentic behavioral profile to a vector database.

2. The method of claim 1, wherein the agent data comprises metadata for the AI agent.

3. The method of claim 1, wherein the agent data comprises a conversation history for AI agent.

4. The method of claim 3, wherein the conversation history comprises a transcript of each of one or more sessions between an end client and the AI agent.

5. The method of claim 3, wherein the conversation history comprises a summary of each of one or more sessions between an end client and the AI agent.

6. The method of claim 1, wherein generating the prompt comprises:
selecting a behavior-specific instruction that is associated with the behavior, from among a plurality of behavior-specific instructions; and
incorporating the at least a portion of the agent data and the behavior-specific instruction into a template, to produce the prompt.

7. The method of claim 1, wherein the generative language model is a large language model.

8. The method of claim 1, wherein the vector space has at least one-hundred dimensions.

9. The method of claim 1, wherein each of the embedding vectors is associated, within the vector database, with an agent identifier of the AI agent.

10. The method of claim 9, wherein each of the embedding vectors is associated, within the vector database, with a behavior identifier of one of the plurality of behaviors that is represented by the embedding vector.

11. The method of claim 1, wherein the plurality of behaviors comprises one or more governance behaviors.

12. The method of claim 1, wherein the plurality of behaviors comprises one or more human-like behaviors.

13. The method of claim 1, wherein the plurality of behaviors comprises one or more governance behaviors and one or more human-like behaviors.

14. The method of claim 1, further comprising using the at least one hardware processor to, by a search engine:
receive a query from an end client;
search the vector database based on the query to produce a search result comprising one or more agent identifiers, wherein each of the one or more agent identifiers identifies one of a plurality of AI agents represented in the vector database; and
return the search result to the end client in response to the query.

15. The method of claim 14, wherein the query defines one or more behaviors, and wherein searching the vector database based on the query to produce the search result comprises:
for each of the one or more defined behaviors,
generating an input embedding vector representing the defined behavior,
generating a vector-database query that queries the vector database for matching reference embedding vectors that are similar, according to one or more similarity criteria, to the input embedding vector, and
executing the vector-database query to retrieve any matching reference embedding vectors;
determine a final set of matching reference embedding vectors; and
add an agent identifier associated with each of the matching reference embedding vectors, in the final set, to the search result.

16. The method of claim 14, wherein the query identifies one or more input AI agents, and wherein searching the vector database based on the query to produce the search result comprises:
for each of the one or more input AI agents,
retrieve at least one embedding vector for the input AI agent from the vector database,
generate a vector-database query that queries the vector database for matching reference embedding vectors that are similar, according to one or more similarity criteria, to the at least one embedding vector, and
execute the vector-database query to retrieve any matching reference embedding vectors;
determine a final set of matching reference embedding vectors; and
add an agent identifier associated with each of the matching reference embedding vectors, in the final set, to the search result.

17. The method of claim 14, wherein the search engine is hosted on an integration platform as a service (iPaaS) platform.

18. The method of claim 1, wherein the profiling service is hosted on an integration platform as a service (iPaaS) platform.

19. A system comprising:
at least one hardware processor; and
software that is configured to, when executed by the at least one hardware processor, perform the method of claim 1.

20. A non-transitory computer-readable medium having instructions stored therein, wherein the instructions, when executed by a processor, cause the processor to perform the method of claim 1.
